(19) United States
(12) Patent Application Publication
(10) Pub. No.: US 2004/0093418 A1
(43) Pub. Date: May 13, 2004

(54) Update of subscriber profiles in a communication system

(76) Inventor: Jukka Tuomi, Tampere (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/292,818

(22) Filed: Nov. 13, 2002

(51) Int. Cl. G06F 15/16

(52) U.S. Cl. 709/228

(57) ABSTRACT

The invention relates to a method for maintaining subscriber profiles in a first communication network, where subscriber-specific data services are provided for terminals operated by users of the network. In order to accomplish a self-provisioning system with respect to subscriber profiles for the first communication network, a location update request is transmitted from said first communication network to a mobile network, the location update request being such that it triggers in the mobile network the sending of a first response, which includes information relating to a subscriber. The first response is received in the first communication network, and the profile of the subscriber is updated by means of the information received in the response.

### FIELD OF THE INVENTION

The invention relates generally to the setting up and maintenance of subscriber profiles in a communication system providing data services to user-operated terminals. More specifically, the invention relates to the retrieval of subscriber-specific information from a mobile network to another network external to the mobile network. In this context, the subscriber-specific information refers to any subscriber-specific information which is available in the mobile network and useful for providing data services in said external network.

### BACKGROUND OF THE INVENTION

The current development towards truly mobile computing and networking has brought on the evolvement of various access technologies which also provide the users with access to the Internet when they are outside their own home network. At present, wireless Internet access is typically based on either wireless LAN technology or mobile networks, or both.

In wireless LAN technology, the mobile terminals are provided with wireless LAN cards, whereby they can access the Internet through wireless LAN access points, which are mainly located in various hot spots, such as airports, convention centers, railway stations, or shopping malls.

An example of the new mobile network technologies enabling Internet access is GPRS (General Packet Radio Service). GPRS aims at providing high-quality services for present GSM subscribers by efficiently utilizing the current network infrastructure and protocols. GPRS evolved from GSM with the introduction of two new network elements: SGSN (Serving GPRS Support Node) and GGSN (Gateway GPRS Support Node). These elements also provide packet-based services in the upcoming UMTS (Universal Mobile Telecommunication System) networks.

The mobile and LAN technologies can also complement each other. An example of this is SIM (Subscriber Identity Module) authentication, which is becoming more common in public WLAN networks. In SIM authentication, the mobile equipment of the user, such as a laptop, PDA or an intelligent phone, is provided with the SIM card of a mobile network, such as the GSM network, and an authentication process is performed, which is highly similar to the one used to authenticate a user in the mobile network. The subscriber-specific information (i.e. subscriber profile) and the subscriber-specific authentication information available in the mobile network can also be copied for the WLAN environment so that SIM-based authentication can be performed locally when the user enters the WLAN network and so that access service can be provided based on the subscriber profile.

So-called multimode radio cards are also becoming more and more common in the user devices. Having his or her mobile terminal equipped with a multimode radio card, the user can choose the network type most suitable in each case, i.e. the user can choose whether the services are accessed through the GPRS or WLAN, for example.

As the traffic of the mobile networks is increasingly data instead of voice, the mobile networks will increasingly contain subscriber information supporting packet data delivery between the terminal device and the network. This information, commonly referred to as the PDP (Packet Data Protocol) context, is stored permanently in the Home Location Register of the subscriber, providing the subscriber has subscribed to packet-switched services. This information would also be useful in the WLAN networks, since WLAN traffic is essentially data traffic.

Currently, the information contained in the PDP context can be reused in the WLAN networks by establishing a new database containing the data stored in the mobile network. One drawback related to these replicate databases is that resources are needed for the provisioning of the databases. (Provisioning refers to the in-advance preparation of said databases.) More particularly, so-called Customer Relationship Management (CRM) tools are needed to set up and maintain the databases in the WLAN networks. Typically, this also involves manual work, i.e. someone must use said tools in order to set up and maintain the databases.

### SUMMARY OF THE INVENTION

The objective of the invention is to accomplish a solution for the above-mentioned problem. In other words, the objective of the invention is to devise a mechanism which enables the efficient reuse of subscriber profiles, such as the PDP contexts, in systems external to the mobile network, such as WLAN networks providing packet-based data services.

In the present invention, the mobility functionalities of the mobile network are utilized by using location update signaling normal in the mobile network to retrieve for the external network the subscriber profiles stored in the mobile network. Due to their hierarchical structure, the mobile networks typically always contain boundaries whose crossing involves authentication of the user, whereby the user profile is transmitted within the network. In the present invention, this functionality is utilized to retrieve the subscriber profile for the external network, and the contents of the subscriber profile are then used in said network for offering access and/or data services to the subscriber. Thus, one element in the external network, which is typically an authentication server, emulates the element of the mobile network which sends the location update message(s) triggering the sending of the subscriber profile. In a GPRS-based environment, this element is the SGSN.

Thus one aspect of the invention is the provision of a method for maintaining subscriber profiles in a first communication network where subscriber-specific data services are provided for terminals operated by users, the method comprising the steps of

transmitting a location update request from the first communication network to a mobile network, the location update request being such that it triggers in the mobile network the sending of a first response, which includes information relating to a subscriber,

receiving the first response in the first communication network, and

updating the profile of the subscriber in the first communication network by means of the information received in the first response from the mobile network.

One drawback of the use of a location update message is that in dual-mode terminals it causes the termination of an active GPRS connection. Therefore, the invention preferably includes a further mechanism for checking whether there is an active GPRS connection for the subscriber just before the subscriber profile is to be retrieved. This is accomplished by sending to the HLR an SMS routing information request, which is normally sent by the SMS gateway MSC (SMS-GMSC) or the Short Message Service Center (SMSC). This message is such that it causes the HLR to return a response which reveals whether there is currently an active GPRS connection for the subscriber. Thus, in a preferred embodiment the authentication server emulates both the SGSN and the SMSC or the SMS-GMSC.

In a further aspect the invention provides a system for maintaining subscriber profiles in a first communication network where subscriber-specific data services are provided, the system comprising

first signaling means for sending a location update request from the first communication network to a mobile network, the location update request being such that it triggers in the mobile network the sending of a first response, which includes information relating to a subscriber,

second signaling means for receiving the first response in said first communication network, and

means for updating the profile of the subscriber in the first communication network by means of the information received in the first response from the mobile network.

In another aspect the invention provides a network element for providing subscriber-specific data services in a first communication network, the network element comprising

first signaling means for sending a location update request from the first communication network to a mobile network, the location update request being such that it triggers in the mobile network the sending of a first response, which includes information relating to a subscriber,

second signaling means for receiving the first response in said first communication network, and

database means for storing subscriber profiles and for updating the profiles based on the information received in said first responses from the mobile network.

By means of the solution of the invention a self-provisioning system is accomplished. Each user may initiate the first retrieval of his or her profile when entering the WLAN network for the first time, and the system can thereafter update the subscriber profiles automatically. Thus, no extra tools or manual work are needed for the provisioning of the system with respect to the subscriber profiles.

Other features and advantages of the invention will become apparent through reference to the following detailed description and accompanying drawings.

### BRIEF DESCRIPTION OF THE DRAWINGS

In the following, the invention and its preferred embodiments are described more closely with reference to the examples shown in FIG. 1 to 3 in the appended drawings, wherein:

FIG. 1 illustrates a typical communication system according to the invention,

FIG. 2 is a flow diagram illustrating the information retrieval according to the invention, and

FIG. 3 is a flow diagram illustrating a preferred embodiment of the invention.

### DETAILED DESCRIPTION OF THE INVENTION

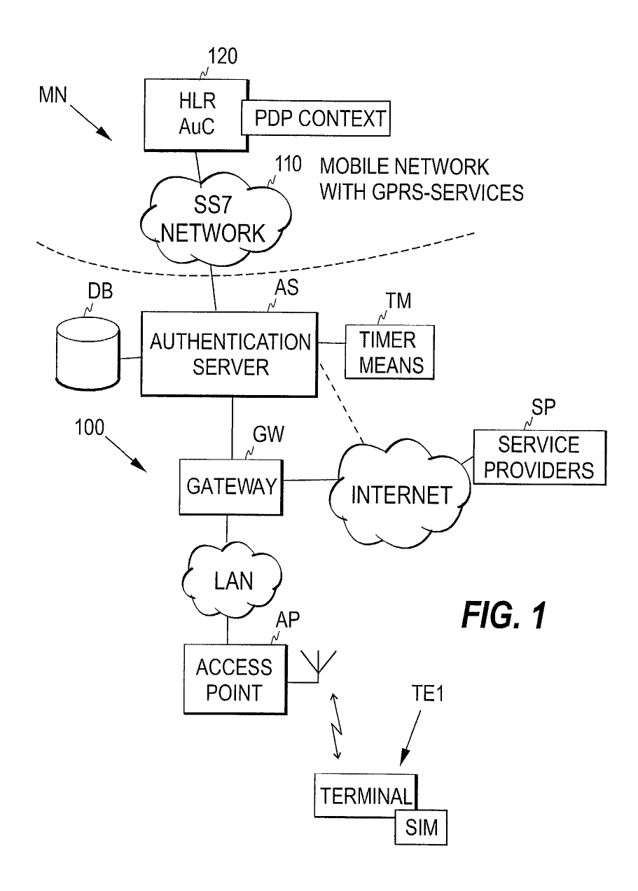

FIG. 1 illustrates a typical communication system according to the invention. The system includes one or more WLAN networks 100, each being connected by means of a gateway GW (a router) to another network, such as the Internet, which contains service providers SP. Each WLAN network comprises one or more access points AP, each communicating wirelessly with the terminals within its coverage and thus forming a bridge between the terminals and the wired LAN, which is typically an Ethernet LAN, within which TCP/IP packets are transmitted.

Users moving in the area of the WLAN network may use portable computers, PDA equipment, intelligent phones or other such terminals. Only one terminal TE1 is illustrated in the figure. In the same way as an ordinary GSM telephone, the terminals are made up of two parts: the actual subscriber device, e.g. a portable computer (with software), and a SIM (Subscriber Identity Module), whereby from the viewpoint of the network the subscriber device becomes a functioning terminal only when the SIM has been inserted into it. The SIM may be the subscriber identity module for use in the GSM network or in the UMTS, for example. In the latter case it is termed the USIM (Universal Services Identity Module).

The heart of the system is an authentication server AS of the WLAN network. The authentication server is connected to the gateway GW through a secured connection, which is typically a TCP/IP connection established through operator network or through the Internet. In addition, the authentication server has access through a signaling network, such as the SS7 network 110, to a separate mobile network MN, which may be a GSM network or an UMTS network, for example. The authentication server AS includes a database DB, which stores the data retrieved from the mobile network. The invention involves the update of the subscriber-specific information in this database, i.e. the WLAN network is the external network referred to above. For the purpose of updating, the authentication server is preferably provided with timer means TM for scheduling the transmissions to the mobile network.

According to the invention, location update signaling known as such is used to retrieve the PDP context stored in the HLR (Home Location Register) 120 of the subscriber to the database of the authentication server. For this purpose, the authentication server emulates the SGSN of the GPRS or UMTS network, as in these networks the SGSN sends the location update request, which informs the HLR that the SGSN for the mobile has changed.

The PDP context stored in the mobile network, e.g. in the HLR, includes various attributes which are useful when the authentication server AS controls or offers data services in the WLAN network. Examples of attributes of the PDP contexts maintained in the GPRS and UMTS systems are the following:

QoS information, which includes the QoS profile subscribed, the QoS profile requested, and the QoS profile negotiated,

Access Point Name (APN) information, which includes the APN subscribed and the APN in use, and

subscribed charging characteristics.

As indicated above, the contents of the PDP context are preferably used in connection with the authentication of the user in the WLAN network, since most of the attributes of the PDP context are normally related to authentication: the QoS information indicates the services or the service class to which the subscriber is entitled, while the APN information indicates the user group of the subscriber and thus also the corresponding service (users with a certain APN are entitled to a certain service at a certain location). However, it is to be noted that the invention is not restricted to be used in connection with authentication but can be used in connection with any such data services, including access services, which may utilize the subscriber-specific information retrieved from the mobile network.

As also indicated above, one drawback in using the location update request is that it causes an active GPRS connection to be terminated. This is because the request triggers the HLR and the “old” SGSN, which is the currently serving SGSN, to exchange the Cancel Location message pair, as a result of which an active GPRS connection is terminated. In other words, the HLR mistakenly assumes that the mobile station has moved to a new SGSN from the currently serving SGSN.

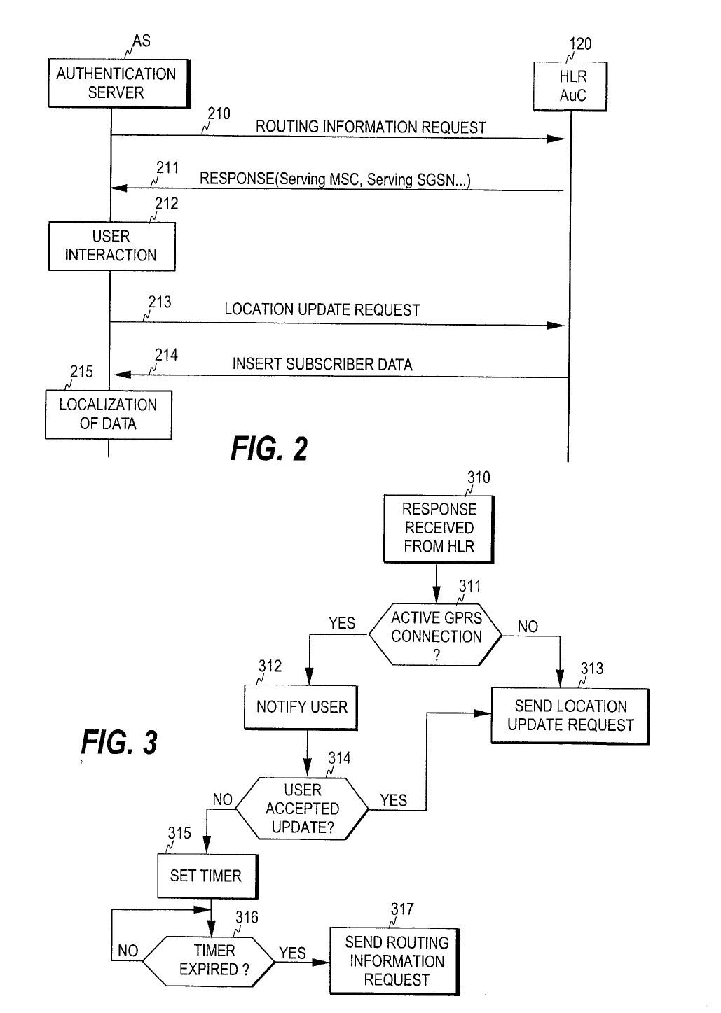

In order to overcome this drawback, a preferred embodiment of the invention includes an additional mechanism for checking whether there is an active GPRS connection for the subscriber at the time the PDP context is to be retrieved from the mobile network. FIG. 2 illustrates this embodiment.

The retrieval of the PDP context from the HLR to the authentication server AS of the WLAN network can be triggered by various events, as discussed below. When such an event has been detected by the authentication server, it checks whether there is currently an active GPRS connection for the subscriber. This is implemented so that the authentication server emulates a Short Message Service Center (SMSC) or SMS gateway MSC (SMS-GMSC) by sending a routing information request to the HLR via the SS7 network (step 210). The service needed to implement this in the GSM/GPRS-based environment of FIG. 1 is the MAP_SEND_ROUTING_INFO_FOR_SM service (defined in 3GPP Technical Specification TS 09.02 v.7.11.0, for example). This service is normally used by the SMSC/SMS-GMSC in order to determine the MSC serving the mobile station. In response to this request, the HLR returns routing information, which includes the identity of the serving MSC (Mobile Services Switching Center), for example (step 211). If there is an active GPRS connection for the subscriber, the response returned by the HLR further includes the identity of the serving SGSN. This feature is utilized in the present invention: if the response does not include the serving SGSN, the authentication server decides that there is not an active GPRS connection for the subscriber, and vice versa.

If the authentication server now detects that there is an active GPRS connection for the subscriber, an interaction can be started with the subscriber in order to notify the subscriber of the situation (step 212). However, this step is optional and is discussed in more detail below in connection with FIG. 3.

If the authentication server detects that there is not currently an active GPRS connection for the subscriber, it sends a location update request to the HLR (step 213). The actual service needed to implement this in the GSM/GPRS-based environment of FIG. 1 is the MAP_UPDATE_GPRS_LOCATION service (as defined in the above-mentioned Technical Specification, for example).

In response to the reception of this request, the HLR returns to the authentication server a response, which includes the PDP context of the subscriber in question (step 214). In the GPRS-based environment of FIG. 1, this service, which is used by the HLR, is called the MAP_INSERT_SUBSCRIBER_DATA service (as defined in the above-mentioned Technical Specification, for example).

The attributes, or some of them, may further be modified for adaptation to the WLAN network (step 215). This localization of data is an optional step required only if some of the attributes received from the mobile network are not directly suitable for use in the WLAN environment.

FIG. 3 is a flow diagram illustrating a preferred embodiment of the invention. In this embodiment, the authentication server performs the above-mentioned pre-check in order to detect an active GPRS connection, and if there is an active GPRS connection for the subscriber, the authentication server notifies the subscriber of an upcoming update of the database.

When the response to the routing information request is received from the HLR (step 310), the authentication server determines (step 311) whether the response included information about the serving SGSN, i.e. whether there is currently an active GPRS connection for the subscriber. If this is not the case, the authentication server sends the location update request to the HLR (step 313) and waits for the response, which includes the PDP context.

If the authentication server detects that the subscriber has an active GPRS connection, it sends a notification to the user (step 312). As a result of this, a message is presented in the display of the terminal device. The message informs the user that the system is about to perform an update of the database, as a result of which the GPRS connection currently active will be terminated and needs to be re-established. The user is then queried whether he/she accepts the update. A window can be opened in the display of the terminal device, for example, the window to contain the information about the update and the consequence of the updating, as well as buttons for accepting or rejecting the update.

If the user accepts the update, by clicking the accept button for example, the authentication server sends the location update request to the HLR. In the opposite case, the authentication server may set a timer (step 315) for making a new check later. When the timer expires, the authentication server sends a new routing information request to the HLR (step 317). When the response to the new request arrives, the above steps are repeated.

In the embodiment of FIG. 3, three optional features of the invention are combined: the in-advance check concerning the active GPRS connection, a notification sent to the user of the terminal, and a timer triggering a new check on the active GPRS connection. These features can also be combined in other ways, depending on the situation. This is discussed in the following.

The authentication server can operate in two modes: active and passive. In the active mode the authentication server retrieves the PDP contexts beforehand, so that the user information is available in the WLAN network when the user enters the said network. The first retrieval can be performed when the initial subscription to the WLAN service is requested. After this, the authentication server can perform periodic updates, e.g. during the night.

In the passive mode, the authentication server retrieves the relevant PDP context when the subscriber enters the WLAN network and is about to use the WLAN service. This case is relevant especially during roaming, when the user has moved outside his or her home network. In case of roaming, the retrieval of the PDP context is carried out in a similar way: the authentication server of the visited WLAN network retrieves the PDP context via a global SS7 network. The operators can agree that the visited WLAN network stores the PDP context for a certain period, such as one week. In this way the GPRS connection of the subscriber is disconnected once a week at the most, if additional authentications are to be performed for the subscriber in the same WLAN network.

In the basic embodiment of the invention, none of the above optional features are used, but the location update request is sent to the HLR regardless of whether or not the subscriber has an active GPRS connection. This embodiment is suitable when the user enters the WLAN network for the first time and the PDP context for the relevant subscriber is thus not yet available for the WLAN network. The basic embodiment can also be used in periodic updates in the active mode during the early morning hours, for example, when it is highly unlikely that the user is utilizing the GPRS service.

The timer, in turn, can be used when the WLAN network spontaneously updates its database in the active mode. As mentioned above, no notification is sent to the user in this case, but the timer is set if there is an active GPRS connection for the subscriber at the time of the update. In this way, the location update request can be sent without causing any disadvantage to the subscriber.

The user interaction, in turn, can be used in the passive mode when the user is utilizing the GPRS service. Instead of a message in the display, the user can also be informed of the upcoming update through an audio message.

The invention was described above using a GPRS network as an example of the network whose location signaling and subscriber profiles are utilized in a WLAN network. However, it is to be noted that the invention can be utilized to retrieve the desired subscriber-specific information from any communication system supporting mobility and including a location update message function which causes said information to be returned, i.e. in any system having services similar to the above-referred MAP_UPDATE_GPRS_LOCATION and MAP_INSERT_SUBSCRIBER_DATA. Thus due to the various system environments possible, the term “mobile network” refers here to a network supporting mobility and including a location update message causing the above-described functionality. Consequently, the desired subscriber-specific information may also reside in conjunction with a network element other than the HLR, depending on the system environment.

Although the invention was described above with reference to the examples shown in the appended drawings, it is obvious that the invention is not limited to these, but may be modified by those skilled in the art without departing from the scope and spirit of the invention. For example, the invention is not restricted to WLAN networks only, but can be used in connection with any system external to the mobile network regardless of the actual access technology, providing the mobile network or another system supporting mobility contains subscriber-specific access information useful for the relevant external system. Such a system may be a Bluetooth or a UWB (Ultra Wide Band) based access system, for example. The method can even be used in conjunction with fixed terminals.

1. A method for maintaining subscriber profiles in a first communication network where subscriber-specific data services are provided for terminals operated by users, the method comprising the steps of
transmitting a location update request from the first communication network to a mobile network, the location update request being such that it triggers in the mobile network the sending of a first response, which includes information relating to a subscriber,
receiving the first response in the first communication network, and
updating the profile of the subscriber in the first communication network by means of the information received in the first response from the mobile network.

2. A method according to claim 1, further comprising the step of sending a routing information request from said first communication network to said mobile network, the routing information request being such that it triggers in the mobile network the sending of a second response, which includes information indicating whether there is currently an active data connection for the subscriber.

3. A method according to claim 2, further comprising the steps of
setting a timer when said second response indicates that the subscriber has an active data connection, and
repeating the sending step when the timer expires.

4. A method according to claim 2, further comprising the step of requesting for the user's acceptance of the transmitting step, said requesting step being performed when the second response indicates that there is an active data connection for the subscriber.

5. A method according to claim 4, further comprising the steps of
setting a timer when the user rejects the transmitting step and
repeating the sending step when the timer expires.

6. A method according to claim 4, wherein said transmitting step is performed in response to the user's acceptance of the transmitting step.

7. A method according to claim 1, wherein said transmitting step is repeated periodically.

8. A method according to claim 3, wherein said sending step is repeated periodically.

9. A method according to claim 1, wherein said location update request is a message according to the MAP_UPDATE_GPRS_LOCATION service and the first response is a message according to the MAP_INSERT_SUBSCRIBER_DATA service.

10. A method according to claim 1, wherein said routing information request is a message according to the MAP_SEND_ROUTING_INFO_FOR_SM service.

11. A method according to claim 1, further comprising the step of modifying said information in the first network, whereby modified information is obtained, said modified information being stored in the updating step.

12. A system for maintaining subscriber profiles in a first communication network where subscriber-specific data services are provided, the system comprising
first signaling means for sending a location update request from the first communication network to a mobile network, the location update request being such that it triggers in the mobile network the sending of a first response, which includes information relating to a subscriber,
second signaling means for receiving the first response in said first communication network, and
means for updating the profile of the subscriber in the first communication network based on the information received in the first response from the mobile network.

13. A system according to claim 12, further including third signaling means for sending a routing information request from said first communication network to said mobile network, the routing information request being such that it triggers in the mobile network the sending of a second response, which includes information indicating whether there is currently an active data connection for the subscriber.

14. A system according to claim 12, further including timer means operably connected to said first signaling means for scheduling the sending of the location update request.

15. A system according to claim 12, further including timer means operably connected to said third signaling means for scheduling the sending of the routing information request.

16. A system according to claim 12, wherein the first communication network is a local access network connected to a network containing service providers.

17. A network element for providing subscriber-specific data services in a first communication network, the network element comprising
first signaling means for sending a location update request from the first communication network to a mobile network, the location update request being such that it triggers in the mobile network the sending of a first response, which includes information relating to a subscriber,
second signaling means for receiving the first response in said first communication network, and
database means for storing subscriber profiles and for updating the profiles based on the information received in said first responses from the mobile network.

18. A network element according to claim 17, further including third signaling means for sending a routing information request from said first communication network to said mobile network, the routing information request being such that it triggers in the mobile network the sending of a second response, which includes information indicating whether there is currently an active data connection for the subscriber.

19. A network element according to claim 17, wherein said first signaling means are adapted to emulate a Serving GPRS Support Node (SGSN) in the sending the location update request.

20. A network element according to claim 18, wherein said third signaling means are adapted to emulate a Short Message Service Center (SMSC) in the sending the routing information request.

21. A network element according to claim 18, wherein said third signaling means are adapted to emulate an SMS gateway MSC (SMS-GMSC) in the sending the routing information request.
